(19) United States
(12) Patent Application Publication
(10) Pub. No.: US 2025/0124600 A1
(43) Pub. Date: Apr. 17, 2025

(54) CAMERA PARAMETER CALCULATION DEVICE, CAMERA PARAMETER CALCULATION METHOD, AND NON-TRANSITORY COMPUTER READABLE RECORDING MEDIUM STORING CAMERA PARAMETER CALCULATION PROGRAM

(71) Applicant: Panasonic Intellectual Property Corporation of America, Torrance, CA (US)

(72) Inventors: Nobuhiko WAKAI, Tokyo (JP); Shigehiro IIDA, Tokyo (JP)

(73) Assignee: Panasonic Intellectual Property Corporation of America, Torrance, CA (US)

(21) Appl. No.: 18/999,922

(22) Filed: Dec. 23, 2024

Related U.S. Application Data
(63) Continuation of application No. PCT/JP2022/044040, filed on Nov. 29, 2022.

(30) Foreign Application Priority Data
Jul. 5, 2022 (JP) 2022-108421

(51) Int. Cl. G06T 7/80; G06T 7/73; G06V 10/44

(52) U.S. Cl. CPC G06T 7/80; G06T 7/73; G06V 10/44

(57) ABSTRACT

A camera parameter calculation device includes: an acquisition part that acquires an image captured by a camera; an estimation part that estimates, from time-series images, time-series node coordinates each indicating an image coordinate of a node of a user; a feature point calculation part that calculates, on the basis of the time-series node coordinates, time-series feature points each showing a reference position of a trunk of the user; and a camera parameter calculation part that calculates a camera parameter for transformation between an image coordinate system and a world coordinate system by minimizing an objective function based on respective distance differences between a walk straight line indicating a walking direction of the user and a plurality of camera sightline straight lines respectively agreeing with a plurality of sightline vectors of the camera corresponding to image coordinates of the time-series feature points.

### FIELD OF INVENTION

The present disclosure relates to a technology of calculating a camera parameter.

### BACKGROUND ART

A geometric-basis way needs to associate a three-dimensional coordinate value in a three-dimensional space with a pixel position in a two-dimensional image to perform camera calibration of a sensing camera or other camera. An image of a repetitive pattern in a known shape has been captured and an intersection or a center of a circle has been detected from the acquired image conventionally to associate the three-dimensional coordinate and the pixel position in the two-dimensional image with each other. An object having the repetitive pattern in the known shape is referred to as a calibration index.

Another conventional way has been proposed to perform camera calibration from an image coordinate of a person who walks straight as seen in a video image. The camera calibration means calculation of a camera parameter.

For instance, Non-patent Literature 1 discloses a geometric-basis way of associating a three-dimensional coordinate value in a three-dimensional space with a pixel position in a two-dimensional image by using a calibration index and thereby calculating a camera parameter.

Further, for instance, Non-patent Literature 2 discloses extracting coordinates of the head and legs of a person walking straight from a video image, and estimating a horizontal line based on a vanishing point from the loci of the head and the legs.

The way in Non-patent Literature 1 requires: capturing an image of the repetitive pattern in a known shape; detecting an intersection or the center of a circle from the acquired image; and associating a three-dimensional coordinate with a pixel position in a two-dimensional image. The way hence may make the calibration operation complicated and fail to provide facilitated camera calibration.

The way in Non-patent Literature 2 may fail to provide camera calibration in a case where no leg is seen or an insufficient distance to estimate a vanishing point is found in an image captured in a narrow space, such as, a residence. The way may fail to provide camera calibration in use of a lens having a distortion like a lens of a fisheye camera or a wide angle camera due to hard estimation of a vanishing point.

Each of the conventional ways faces difficulty in providing the camera calibration in use of a sensing camera arranged in a residence due to complicated setting of a calibration index or a lack of walking distance required for the camera calibration.

Non-patent Literature 1: R. Y. Tsai, “A Versatile Camera Calibration Technique for High-Accuracy 3D Machine Vision Metrology Using Off-the-Shelf TV Cameras and Lenses”, IEEE Journal of Robotics and Automation, Volume 3, Number 4, Pages 323 to 344, August 1987

Non-patent Literature 2: F. Lv, T. Zhao, R. Nevatia, “Camera Calibration from Video of a Walking Human”, IEEE Transactions on Pattern Analysis and Machine Intelligence, Volume 28, Number 9, pages 1513-1518 September 2006

### SUMMARY OF THE INVENTION

The present disclosure has been accomplished to solve the drawbacks described above, and has an object of providing a technology of calculating a camera parameter without a calibration index even in a case of a short walking distance.

A camera parameter calculation device according to the present disclosure includes: an acquisition part that acquires an image captured by a camera; an estimation part that estimates, from time-series images acquired by the acquisition part, time-series node coordinates each indicating an image coordinate of a node of a user; a feature point calculation part that calculates, on the basis of the time-series node coordinates estimated by the estimation part, time-series feature points each showing a reference position of a trunk of the user; and a camera parameter calculation part that calculates a camera parameter for transformation between an image coordinate system and a world coordinate system by minimizing an objective function based on respective distance differences between a walk straight line indicating a walking direction of the user and a plurality of camera sightline straight lines respectively agreeing with a plurality of sightline vectors of the camera corresponding to image coordinates of the time-series feature points.

The present disclosure achieves calculation of a camera parameter without a calibration index even in a case of a short walking distance.

### BRIEF DESCRIPTION OF THE DRAWINGS

FIG. 1 is a block diagram showing an example of a configuration of a camera parameter calculation system in a first embodiment of the present disclosure.

FIG. 2 is an illustration of an example of node information about nodes estimated by an estimation part.

FIG. 3 is a flowchart showing an example of a process of calculating a camera parameter by a camera parameter calculation device in the first embodiment of the disclosure.

FIG. 4 is an illustration of an example of a feature point in an image captured by photographing a user who is walking.

FIG. 5 is a graph showing an example of a polynomial trendline for correcting time-series feature points.

FIG. 6 is a schematic view for explaining calculation of the camera parameter by a camera parameter calculation part.

FIG. 7 is a block diagram showing an example of a configuration of a camera parameter calculation system in a second embodiment of the present disclosure.

FIG. 8 is a flowchart showing an example of a process of calculating a camera parameter by a camera parameter calculation device in the second embodiment of the disclosure.

### DETAILED DESCRIPTION

### Knowledge Forming the Basis of the Present Disclosure

In recent years, camera calibration has been required for sensing by a camera to recognize an image with a high accuracy. In a case where a camera is arranged in a commercial facility or outdoors, a contractor can perform the camera calibration. By contrast, a photographing place which is too narrow to arrange a calibration index has a drawback that a conventional camera calibration way is unadoptable therefor. In particular, this drawback is likely to be seen in a residence due to a restriction on an arrangement position of the camera. This makes it difficult for the conventional camera calibration way to calculate a camera parameter of the camera arranged in the residence.

The following technologies will be described to solve the drawbacks.

(1) A camera parameter calculation device according to one aspect of the present disclosure includes: an acquisition part that acquires an image captured by a camera; an estimation part that estimates, from time-series images acquired by the acquisition part, time-series node coordinates each indicating an image coordinate of a node of a user; a feature point calculation part that calculates, on the basis of the time-series node coordinates estimated by the estimation part, time-series feature points each showing a reference position of a trunk of the user; and a camera parameter calculation part that calculates a camera parameter for transformation between an image coordinate system and a world coordinate system by minimizing an objective function based on respective distance differences between a walk straight line indicating a walking direction of the user and a plurality of camera sightline straight lines respectively agreeing with a plurality of sightline vectors of the camera corresponding to image coordinates of the time-series feature points.

This configuration expresses a plurality of sightline vectors of the camera corresponding to image coordinates of the time-series feature points by using the time-series feature points each showing a reference position of the trunk of the user and a camera parameter for transformation between an image coordinate system and a world coordinate system. Then, the camera parameter is calculated by minimizing an objective function based on respective distance differences between the walk straight line indicating the walking direction of the user and the camera sightline straight lines respectively agreeing with a plurality of sightline vectors. When the camera parameter has an error or a difference, the walk straight line does not intersect the camera sightline straight lines, and distance differences between the walk straight line and the camera sightline straight lines are made. The camera parameter is optimized to make each distance difference smallest, so that the camera parameter is calculated. At this time, presence of the same number of time-series images as the number of calculated camera parameters to be calculated leads to achievement of calculation of the camera parameters. This consequently enables calculation of each camera parameter without a calibration index even in a case of a short walking distance.

(2) In the camera parameter calculation device according to (1) above, the sightline vectors may be calculated so as to respectively correspond to the image coordinates of the time-series feature points by using the time-series feature points calculated by the feature point calculation part and the camera parameter.

This configuration enables expression of the sightline vectors by using the time-series feature points calculated by the feature point calculation part and the camera parameter.

(3) The camera parameter calculation device according to (1) or (2) above may further include an output part that outputs the camera parameter calculated by the camera parameter calculation part.

This configuration in which the output camera parameter is stored whenever enables image processing including removal of a distortion of an image by using the stored camera parameter.

(4) In the camera parameter calculation device according to any one of (1) to (3) above, the camera parameter calculation part may use, as the objective function, a sum of the distance differences between the walk straight line and the camera sightline straight lines.

This configuration adopting a sum of distance differences as an objective function enables calculation of an optimal camera parameter.

(5) In the camera parameter calculation device according to any one of (1) to (3) above, the camera parameter calculation part may use, as the objective function, a sum of respective squares of the distance differences between the walk straight line and the camera sightline straight lines.

This configuration adopting a sum of respective squares of the distance differences as the objective function enables calculation of an optimal camera parameter.

(6) The camera parameter calculation device according to any one of (1) to (5) above may further include a determination part that determines, on the basis of the time-series feature points calculated by the feature point calculation part, whether the user walks straight. The camera parameter calculation part may calculate the camera parameter when the user is determined to walk straight.

This configuration executes calculation of a camera parameter when the user walks straight and avoids calculating the camera parameter when the user does not walk straight, and hence enables calculation of the camera parameter with a high accuracy.

(7) In the camera parameter calculation device according to any one of (1) to (6) above, the feature point calculation part may calculate respective polynomial trendlines for x-coordinates and y-coordinates of the time-series feature points on the basis of the image coordinates of the calculated time-series feature points, and correct a value on each of an x-coordinate and a y-coordinate of each of the time-series feature points by using the calculated polynomial trendlines for the x-coordinates and the y-coordinates.

In this configuration, the estimated time-series node coordinates may include an error or a difference. However, the polynomial trendlines for x-coordinates and y-coordinates are used to correct a value on each of an x-coordinate and a y-coordinate of each of the time-series feature points. This results in a linear locus of the time-series feature points. The configuration therefore enables calculation of the camera parameter with a high accuracy.

(8) The camera parameter calculation device according to any one of (1) to (7) above may further include a setting storage part that stores a distortion parameter indicating a distortion of a lens of the camera in advance. The camera parameter calculation part may use the distortion parameter stored in the setting storage part as a part of the camera parameter to express the sightline vectors.

This configuration has no need of calculating a distortion parameter indicating a distortion of a lens of the camera, and thus achieves saving of a time required for calculating the camera parameter.

Moreover, the disclosure can be realized as: a camera parameter calculation device including the above-described distinctive configuration; and a camera parameter calculation method executing distinctive ways each corresponding to the distinctive configuration of the camera parameter calculation device. Additionally, the disclosure can be realized by a computer program causing a computer to execute the distinctive ways included in the camera parameter calculation method. From these perspectives, the same advantageous effects as those of the camera parameter calculation device are achievable in the following other aspects.

(9) A camera parameter calculation method according to another aspect of the present disclosure is a camera parameter calculation method in a computer. The camera parameter calculation method includes: acquiring an image captured by a camera; estimating, from time-series images having been acquired, time-series node coordinates each indicating an image coordinate of a node of a user; calculating, on the basis of the estimated time-series node coordinates, time-series feature points each showing a reference position of a trunk of the user; and calculating a camera parameter for transformation between an image coordinate system and a world coordinate system by minimizing an objective function based on respective distance differences between a walk straight line indicating a walking direction of the user and a plurality of camera sightline straight lines respectively agreeing with a plurality of vectors of the camera corresponding to image coordinates of the time-series feature points.

(10) A camera parameter calculation program according to another aspect of the present disclosure includes: causing a computer to serve as: an acquisition part that acquires an image captured by a camera; an estimation part that estimates, from time-series images acquired by the acquisition part, time-series node coordinates each indicating an image coordinate of a node of a user; a feature point calculation part that calculates, on the basis of the time-series node coordinates estimated by the estimation part, time-series feature points each showing a reference position of a trunk of the user; and a camera parameter calculation part that calculates a camera parameter for transformation between an image coordinate system and a world coordinate system by minimizing an objective function based on respective distance differences between a walk straight line indicating a walking direction of the user and a plurality of camera sightline straight lines respectively agreeing with a plurality of sightline vectors of the camera corresponding to image coordinates of the time-series feature points.

The disclosure can be realized as a camera parameter calculation system caused to operate by the camera parameter calculation program as well. Additionally, it goes without saying that the computer program is distributable as a non-transitory computer readable storage medium like a CD-ROM, or distributable via a communication network like the Internet.

(11) A non-transitory computer readable medium according to still another aspect of the present disclosure stores a camera parameter calculation program. The camera parameter calculation program further causes the computer to serve as: an acquisition part that acquires an image captured by a camera; an estimation part that estimates, from time-series images acquired by the acquisition part, time-series node coordinates each indicating an image coordinate of a node of a user; a feature point calculation part that calculates, on the basis of the time-series node coordinates estimated by the estimation part, time-series feature points each showing a reference position of a trunk of the user; and a camera parameter calculation part that calculates a camera parameter for transformation between an image coordinate system and a world coordinate system by minimizing an objective function based on respective distance differences between a walk straight line indicating a walking direction of the user and a plurality of camera sightline straight lines respectively agreeing with a plurality of sightline vectors of the camera corresponding to image coordinates of the time-series feature points.

Each of the embodiments which will be described below represents a specific example of the disclosure. Numeric values, shapes, constituent elements, steps, and the order of the steps described below in each embodiment are mere examples, and thus should not be construed to delimit the disclosure. Moreover, constituent elements which are not recited in the independent claims each showing the broadest concept among the constituent elements in the embodiments are described as selectable constituent elements. The respective contents are combinable with each other in all the embodiments.

### First Embodiment

Hereinafter, a first embodiment of the disclosure will be described with reference to the accompanying drawings.

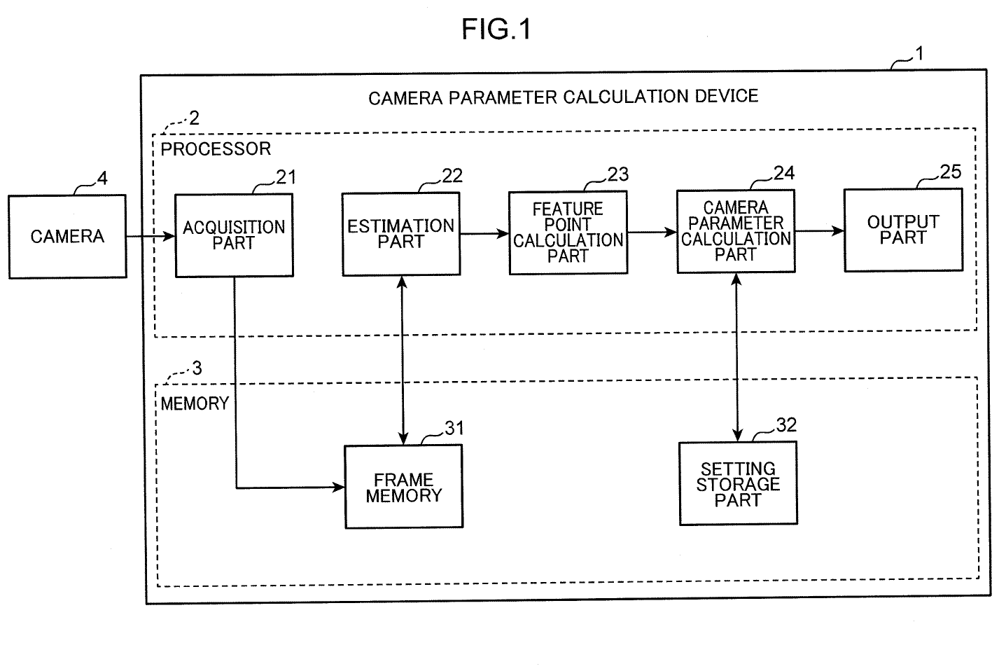

FIG. 1 is a block diagram showing an example of a configuration of a camera parameter calculation system in the first embodiment of the present disclosure.

The camera parameter calculation system includes a camera parameter calculation device 1 and a camera 4.

In the first embodiment, the camera 4 is a fixed camera which is arranged in a residence where a user to be a recognition target in sensing lives. The camera 4 captures an image of the user at a predetermined frame rate and inputs the captured image into the camera parameter calculation device 1 at a predetermined frame rate.

The camera parameter calculation device 1 is composed of a computer including a processor 2, a memory 3, and an interface circuit (not shown). The processor 2 includes, for example, a central processing unit. The memory 3 includes a non-volatile and rewritable storage device, e.g., a flash memory, a hard disk drive, or a solid state drive. The interface circuit includes, for example, a communication circuit.

The camera parameter calculation device 1 may include an edge server provided in the residence, may include a smart speaker provided in the residence, or may include a cloud server. When the camera parameter calculation device 1 includes the edge server or the smart speaker, the camera 4 and the camera parameter calculation device 1 are connected to each other via a local area network. When the camera parameter calculation device 1 includes the cloud server, the camera 4 and the camera parameter calculation device 1 are connected to each other via a wide area network like the internet. Here, a part of the configuration of the camera parameter calculation device 1 may be provided on the edge server, and the remaining part thereof may be provided on the cloud server.

The processor 2 has an acquisition part 21, an estimation part 22, a feature point calculation part 23, a camera parameter calculation part 24, and an output part 25. Each of the acquisition part 21 to the output part 25 may come into effect when the central processing unit executes the camera parameter calculation program, or may be established in the form of a dedicated hardware circuit, such as an application specific integrated circuit (ASIC).

The acquisition part 21 acquires the image captured by the camera 4. The acquisition part 21 stores the acquired image in a frame memory 31.

The estimation part 22 estimates, from time-series images acquired by the acquisition part 21, time-series node coordinates each indicating an image coordinate of a node of the user. The estimation part 22 estimates a plurality of nodes of the user and reliability of each of the nodes from the image read out from the frame memory 31. The estimation part 22 estimates each of the nodes and the reliability thereof by inputting the image into a learned model obtained through machine learning of a relation between the image and the node. An example of the learned model is a deep neural network. An example of the deep neural network is a convolutional neural network including a convolutional layer and a pooling layer. The estimation part 22 may include a learning model other than the deep neural network.

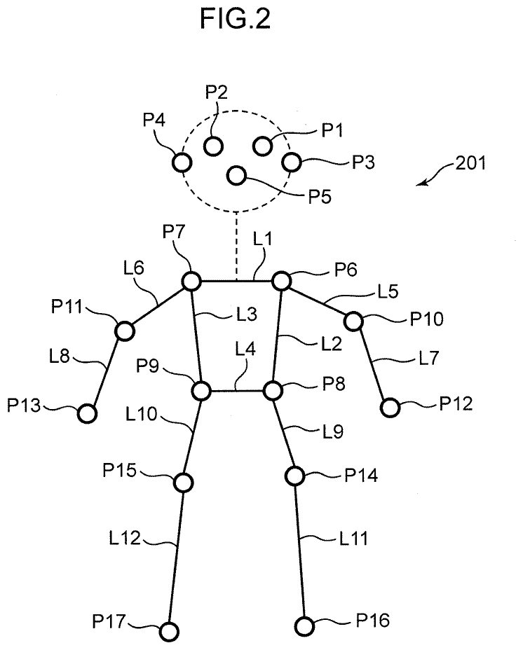

FIG. 2 is an illustration of an example of node information 201 about nodes P1 to P17 estimated by the estimation part 22.

The node information 201 includes information about the nodes P1 to P17 of one person. The node information 201 shows, for example, the node P1 of the left eye, the node P2 of the right eye, the node P3 of the left ear, the node P4 of the right ear, the node P5 of the nose, the node P6 of the left shoulder, the node P7 of the right shoulder, the node P8 of the left waist, the node P9 of the right waist, the node P10 of the left elbow, the node P11 of the right elbow, the node P12 of the left wrist, the node P13 of the right wrist, the node P14 of the left knee, the node P15 of the right knee, the node P16 of the left ankle, and the node P17 of the right ankle. The node information 201 includes the seventeen nodes P1 to P17.

The estimation part 22 estimates the seventeen nodes P1 to P17. The node information 201 further includes links L1 to L12 linking the nodes to each other. For instance, the node information 201 includes the link L1 linking the node P6 of the left shoulder and the node P7 of the right shoulder to each other, the link L2 linking the node P6 of the left shoulder and the node P8 of the left waist to each other, the link L3 linking the node P7 of the right shoulder and the node P9 of the right waist to each other, the link L4 linking the node P8 of the left waist and the node P9 of the right waist to each other, the link L5 linking the node P6 of the left shoulder and the node P10 of the left elbow to each other, the link L6 linking the node P7 of the right shoulder and the node P11 of the right elbow to each other, the link L7 linking the node P10 of the left elbow and the node P12 of the left wrist to each other, the link L8 linking the node P11 of the right elbow and the node P13 of the right wrist to each other, the link L9 linking the node P8 of the left waist and the node P14 of the left knee to each other, the link L10 linking the node P9 of the right waist and the node P15 of the right knee to each other, the link L11 linking the node P14 of the left knee and the node P16 of the left ankle to each other, and the link L12 linking the node P15 of the right knee and the node P17 of the right ankle to each other.

In FIG. 2, dashed lines represent auxiliary lines respectively denoting an outline of a face and a location of a neck. Each of the nodes P1 to P17 is expressed on an X-coordinate and a Y-coordinate denoting the position on the image. The node information 201 is expressed by an indicator uniquely specifying each of the nodes P1 to P17, the coordinate of each of the nodes P1 to P17, and reliability of each of the nodes P1 to P17. For instance, the node information 201 is expressed in a dictionary format, such as {an indicator “right eye”: [X-coordinate, Y-coordinate, reliability], an indicator “left eye”: [X-coordinate, Y-coordinate, reliability], . . . , an indicator “left ankle”: [X-coordinate, Y-coordinate, reliability]}.

The reliability is estimated by the estimation part 22 for each of the nodes P1 to P17. The reliability expresses a certainty of each of the estimated nodes P1 to P17 with a probability. The certainty increases as a value of the reliability increases. The reliability takes, for example, a value falling within a range from 0 to 1. In the example shown in FIG. 2, the node information 201 shows the seventeen nodes P1 to P17, but this is just an example. The number of nodes P1 to P17 may be changed to sixteen or smaller, or changed to eighteen or larger. In this case, the learned model may be configured to estimate a predetermined number of nodes that is sixteen or smaller, or eighteen or larger. The node information 201 may further show other nodes (e.g., nodes of a finger, a mouth, and other parts) in addition to the nodes P1 to P17 shown in FIG. 2.

The feature point calculation part 23 calculates a feature point from the nodes P1 to P17 estimated by the estimation part 22. The feature point calculation part 23 calculates, on the basis of the time-series node coordinates estimated by the estimation part 22, time-series feature points each showing a reference position of a trunk of the user. The feature point calculation part 23 further calculates respective polynomial trendlines for x-coordinates and y-coordinates of the time-series feature points on the basis of the image coordinates of the calculated time-series feature points. The feature point calculation part 23 then corrects a value on each of an x-coordinate and a y-coordinate of each of the time-series feature points by using the calculated polynomial trendlines for the x-coordinates and the y-coordinates. The feature point calculation part 23 will be described in detail later.

The camera parameter calculation part 24 calculates a camera parameter on the basis of the feature point calculated by the feature point calculation part 23 and a setting stored in a setting storage part 32. The camera parameter calculation part 24 calculates a camera parameter for transformation between an image coordinate system and a world coordinate system by minimizing an objective function based on respective distance differences between a walk straight line indicating a walking direction of the user and a plurality of camera sightline straight lines respectively agreeing with a plurality of sightline vectors of the camera corresponding to image coordinates of the time-series feature points. The sightline vectors are calculated so as to respectively correspond to the image coordinates of the time-series feature points by using the time-series feature points calculated by the feature point calculation part 23 and the camera parameter. The camera parameter calculation part 24 will be described in detail later.

The output part 25 outputs the camera parameter calculated by the camera parameter calculation part 24.

The memory 3 has the frame memory 31 and the setting storage part 32. The frame memory 31 stores an image acquired by the acquisition part 21 from the camera 4. The frame memory 31 stores time-series images acquired by the acquisition part 21.

The setting storage part 32 stores a setting of the arranged camera 4. The setting storage part 32 stores a distortion parameter indicating a distortion of a lens of the camera 4 in advance. The camera parameter calculation part 24 uses the distortion parameter stored in the setting storage part 32 as a part of the camera parameter to express the sightline vectors. The setting storage part 32 will be described in detail later.

The camera parameter calculation device 1 may not be necessarily achieved by a single computer device, but may be achieved by a decentralization system (not shown) including a terminal device and a server. In this case, the acquisition part 21, the frame memory 31, and the estimation part 22 may be provided in the terminal device, and the setting storage part 32, the feature point calculation part 23, the camera parameter calculation part 24, and the output part 25 may be provided on the server. In this case, the relevant constituent elements transfer data therebetween via a wide area network.

Heretofore, the configuration of the camera parameter calculation device 1 has been described. Subsequently, a process of calculating a camera parameter by the camera parameter calculation device 1 will be described.

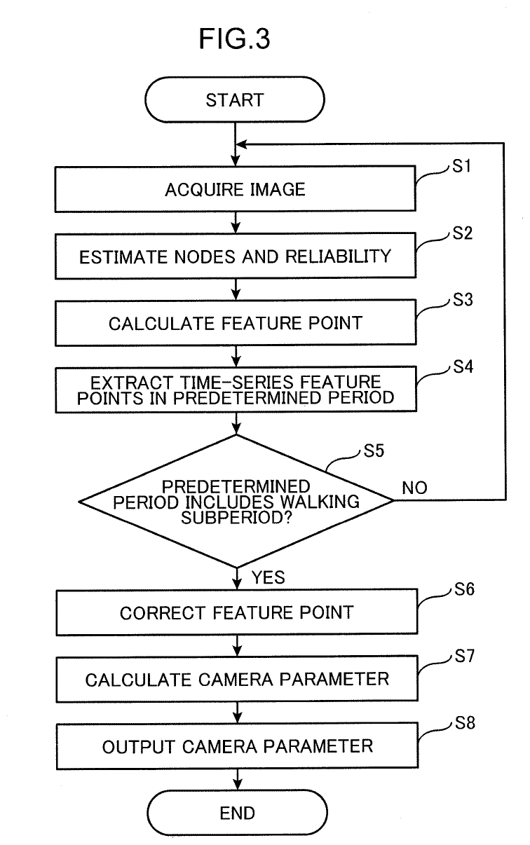

FIG. 3 is a flowchart showing an example of the process of calculating a camera parameter by the camera parameter calculation device 1 in the first embodiment of the disclosure. The process of calculating a camera parameter is performed at arrangement of the camera 4, and is performed periodically thereafter, for example, every one week or every one month.

First, in step S1, the acquisition part 21 acquires an image from the camera 4. The acquisition part 21 stores the acquired image in the frame memory 31.

Next, in step S2, the estimation part 22 acquires a plurality of time-sequence images from the frame memory 31 and estimates a plurality of nodes and reliability of each of the nodes concerning each of the images by inputting the acquired time-series images into a learned model. What is described here for simplification is that images each captured by photographing one user who is walking and thus each showing the one user are used to calculate a camera parameter. However, this is just an example, and an image captured by photographing a plurality users who are walking may be used for calculating a camera parameter.

The estimation part 22 traces the user in time series in estimation of each node and the reliability. The tracing of the user may be determined by identifying a person having the most similar center gravity of a bounding rectangle of a plurality of node coordinates among the time-series continuous images to be identical to the user, or may be determined by the Hungarian notation in such a manner that a set of gravity center distances of bounding rectangles is minimum. The estimation part 22 specifies the user for calculation of a camera parameter. For instance, the estimation part 22 selects a user having the largest average area of time-series bounding rectangle areas of nodes.

The estimation part 22 may estimate only each node without estimating the reliability of the node.

Subsequently, in step S3, the feature point calculation part 23 calculates a feature point from the node coordinates estimated by the estimation part 22.

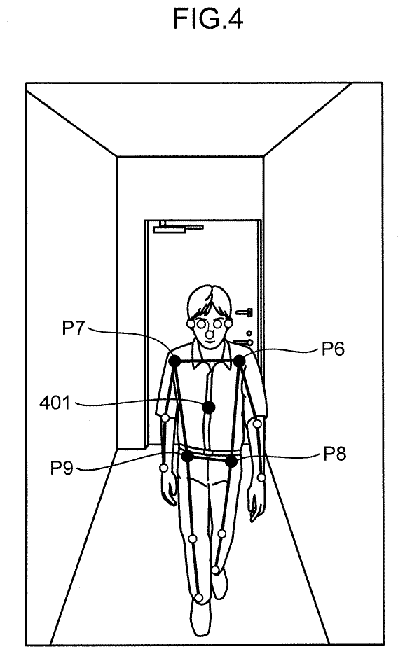

FIG. 4 is an illustration of an example of a feature point 401 in an image captured by photographing a user who is walking.

The feature point represents a reference point of an upper body on an image coordinate and indicates a gravity center on node coordinates of a trunk. The feature point calculation part 23 calculates, as the feature point 401, the gravity center coordinate of the four nodes P6 to P9 of both the shoulders and both the waists. Such a node as not detected due to an obstacle or an orientation of the body is excluded from the calculation of the feature point. The feature point calculation part 23 avoids calculating a feature point at no detection of a node which is required for the calculation of the gravity center, records information indicating “no feature point” in association with an image in place of the feature point, and ignores the image in calculation of the camera parameter.

The feature point calculation part 23 may calculate the gravity center coordinate of the trunk by defining the reliability of each of the nodes P6 to P9 as weighting. The feature point calculation part 23 may calculate, as the feature point 401, the gravity center coordinate of the bounding rectangle covering the trunk in place of the gravity center of the nodes P6 to P9 of both the shoulders and both the waists. The nodes for use in calculating the gravity center may include the nodes of both the knees and both the elbows without limitation to the nodes P6 to P9 of both the shoulders and both the waists.

The feature point calculation part 23 may further calculate the feature point only from a node having reliability which is higher than a threshold.

Subsequently, in step S4, the feature point calculation part 23 extracts time-series feature points in a predetermined period. The predetermined period indicates a period from a current time to a specific time in past (e.g., ten seconds before).

Then, in step S5, the feature point calculation part 23 determines whether the predetermined period includes a walking subperiod during which the user walks. The walking subperiod is equal to or longer than a period of a threshold during which a plurality of time-series feature points is continuous. Examples of the threshold include two seconds. The feature point calculation part 23 selects time-series feature points in the walking subperiod. When the predetermined period includes a plurality of walking subperiods, the feature point calculation part 23 selects time-series feature points in a walking subperiod which is longest. Here, when the predetermined period is determined not to include a walking subperiod (NO in step S5), the process returns to step S1.

In a case where the user who is walking is photographed from the front, a feature point may be calculated, but no movement may be seen in time-series feature points. The feature point calculation part 23 may determine that the predetermined period includes no walking subperiod when no movement is seen in a locus of the time-series feature points.

Alternatively, the user may designate the predetermined period. For instance, a terminal carried by the user may receive respective inputs of a photographing start instruction and a photographing finish instruction by the user. The user may start to walk after the input of the photographing start instruction and may input the photographing finish instruction after a finish of the walking. The terminal sends the photographing start instruction and the photographing finish instruction to the camera parameter calculation device 1. A communication part (not shown) of the camera parameter calculation device 1 receives the photographing start instruction and the photographing finish instruction. The feature point calculation part 23 may define a predetermined period from a time of the input of the photographing start instruction to a time of the input of the photographing finish instruction, and extract time-series feature points in the predetermined period.

An input part (not shown) of the camera parameter calculation device 1 may receive designation of the predetermined period by the operator from a video image captured in advance.

By contrast, when the predetermined period is determined to include a walking subperiod (YES in step S5), the feature point calculation part 23 corrects each calculated time-series feature point in step S6. The node coordinates estimated by the estimation part 22 include an estimation error or difference, and thus, a locus of the time-series feature points on the image is not smooth. Therefore, the feature point calculation part 23 approximates the time-series feature points by a polynomial to form a smooth movement locus of the time-series feature points on the image.

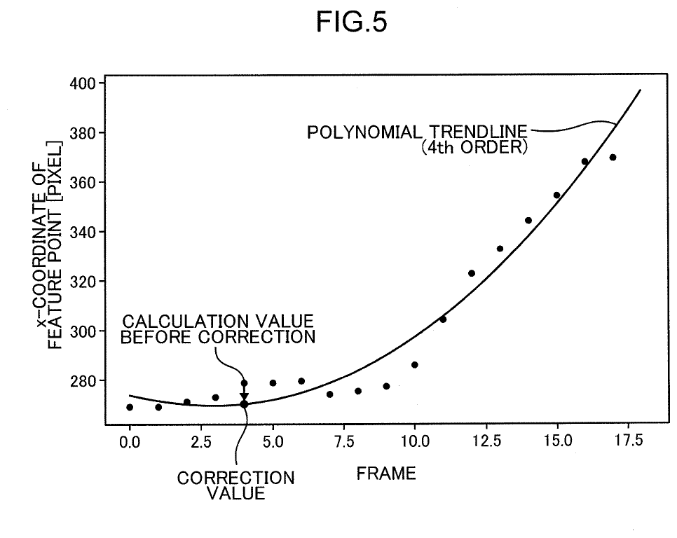

FIG. 5 is a graph showing an example of a polynomial trendline for correcting time-series feature points. In FIG. 5, the horizontal axis denotes a frame and the vertical axis denotes an x-coordinate of a feature point.

First, the feature point calculation part 23 calculates respective polynomial trendlines for x-coordinates of the time-series feature points on the basis of image coordinates of the calculated time-series feature points. When plotting a value (v) of each of x-coordinates (in a horizontal direction of an image) of time-series feature points to a value (u) of a frame (time) associated with each of the time-series feature points, the feature point calculation part 23 fits the polynomial g with “v=g(u)” to the time-series feature points and calculates polynomial trendlines. The N-th order of the polynomial g is, for example, “the 4th order”.

The feature point calculation part 23 then corrects a value on each of the x-coordinates of the time-series feature points by using the calculated polynomial trendlines for the x-coordinates. The feature point calculation part 23 calculates a correction value v of a feature point on the x-coordinate by assigning a value of a calculated value u of the feature point before correction into the polynomial g.

Similarly, the feature point calculation part 23 calculates a correction value of the feature point on a y-coordinate (in a vertical direction of the image). Specifically, the feature point calculation part 23 calculates polynomial trendlines for the y-coordinates of the time-series feature points on the basis of image coordinates of the calculated time-series feature points. The feature point calculation part 23 then corrects a value on each of y-coordinates of the time-series feature points by using the calculated polynomial trendlines for the y-coordinates.

Next, in step S7, the camera parameter calculation part 24 calculates a camera parameter on the basis of the time-series feature points calculated by the feature point calculation part 23 and a set value which is related to the residence of the user and is stored in the setting storage part 32.

Subsequently, in step S8, the output part 25 outputs the camera parameter calculated by the camera parameter calculation part 24.

The above-described procedure achieves calibration of the camera 4 arranged in the residence for sensing. In particular, the first embodiment is useful for camera calibration in a residence having many restrictions for arrangement of the camera 4.

An example of the camera parameter in this disclosure will be described below. A transformation formula for transformation from the world coordinate system into the image coordinate system will be expressed with the following Equations (1) to (4). The camera parameter is a projection parameter resulting from projecting the world coordinate system onto an image coordinate. The sign “Γ(η)” in Equation (3) denotes a projection function indicating a lens distortion, and an example of the function is a pinhole camera model expressed with the equation “Γ(η)=f tan (η)”. The sign “f” denotes a focal distance and the sign “η” denotes an incident angle.

$$[ \begin{matrix}x \\ y \\ 1\end{matrix} ] = [ \begin{matrix}γ / {d}_{x} & 0 & {C}_{x} & 0 \\ 0 & γ / {d}_{y} & {C}_{y} & 0 \\ 0 & 0 & 0 & 1\end{matrix} ] [ \begin{matrix}{X}_{e} \\ {Y}_{e} \\ {Z}_{e} \\ 1\end{matrix} ] \qquad ( 1 )$$

$$[ \begin{matrix}{X}_{e} \\ {Y}_{e} \\ {Z}_{e} \\ 1\end{matrix} ] = [ \begin{matrix}{r}_{11} & {r}_{12} & {r}_{13} & {T}_{X} \\ {r}_{21} & {r}_{22} & {r}_{23} & {T}_{Y} \\ {r}_{31} & {r}_{32} & {r}_{33} & {T}_{Z} \\ 0 & 0 & 0 & 1\end{matrix} ] [ \begin{matrix}X \\ Y \\ Z \\ 1\end{matrix} ] \qquad ( 2 )$$

$$γ = Γ ( η ) \qquad ( 3 )$$

$$η = arctan ( \frac{\sqrt{{X}_{e}^{2} + {Y}_{e}^{2}}}{{Z}_{e}} ) \qquad ( 4 )$$

Here, the coordinate “(X, Y, X)” denotes a world coordinate system value, and the coordinate “(x, y)” denotes an image coordinate value. The coordinate “(Cₓ, C_{y})” denotes a principal point image coordinate of the camera 4, the signs “r₁₁” to “r₃₃” denote components of a 3×3 rotation matrix R representing a rotation with respect to a reference of the world coordinate, and the vector “(T_{X}, T_{Y}, T_{Z})” denotes a translation vector with respect to the reference of the world coordinate, and the signs “dₓ” and “d_{y}” respectively denote a horizontal pixel pitch and a vertical pixel pitch of an image sensor of the camera 4. In Equations (1) to (4), each of the signs “dₓ”, “d_{y}”, “Cₓ”, “C_{y}”, “r₁₁” to “r₃₃”, “T_{X}”, “T_{Y}”, and “T_{Z}” is a camera parameter.

Each of Equations (1) to (4) shows transformation from “(X, Y, Z)” into “(x, y)”. An inverse function or an inverse matrix of each of Equation (1) to (4) is used for transformation from “(x, y)” into “(X, Y, Z)” on a unit sphere. A rotation matrix is regular, and an inverse matrix is always calculatable. A matrix of 4×4 including a translation vector is also regular. Hence, for example, when the inverse function of “Γ” is calculatable, like that of the pinhole camera, the transformation from “(x, y)” into “(X, Y, Z)” on the unit sphere is attainable.

The lens distortion Γ may be calculated through calibration of the camera 4 in advance, a designed value for the lens may be adopted for the lens distortion, or a pinhole camera may be supposed for the lens distortion. The lens distortion Γ is expressed by a function or a table equivalent to the function. The lens distortion Γ is stored in the setting storage part 32. The camera parameter calculation part 24 acquires the lens distortion T from the setting storage part 32. The walk of the user is defined as a uniform linear motion for simple description. Concerning the uniform linear motion, a position (the gravity center of the trunk) of a feature point in a three-dimensional space is on a straight line. When the walk of the user is a non-uniform linear motion, the camera parameter calculation part 24 enables calculation by expressing the walking velocity of the user with a plurality of parameters and adding the parameters indicating the walking velocity to the camera parameters.

The setting storage part 32 may store the principal point image coordinate (Cₓ, C_{y}) of the camera 4 and the horizontal and vertical pixel pitches dₓ and d_{y} of the image sensor of the camera 4 in advance.

Definition of the walk of the user as the uniform linear motion results in permitting use of the calculated gravity center position, i.e., the feature point, of the trunk of the person as a calibration index in Non-patent Literature 1. Moreover, the calculated feature point is more unstable than the calibration index, and thus, the feature point is corrected so that time-series feature points in images smoothly change.

Subsequently, calculation of a camera parameter by the camera parameter calculation part 24 will be described.

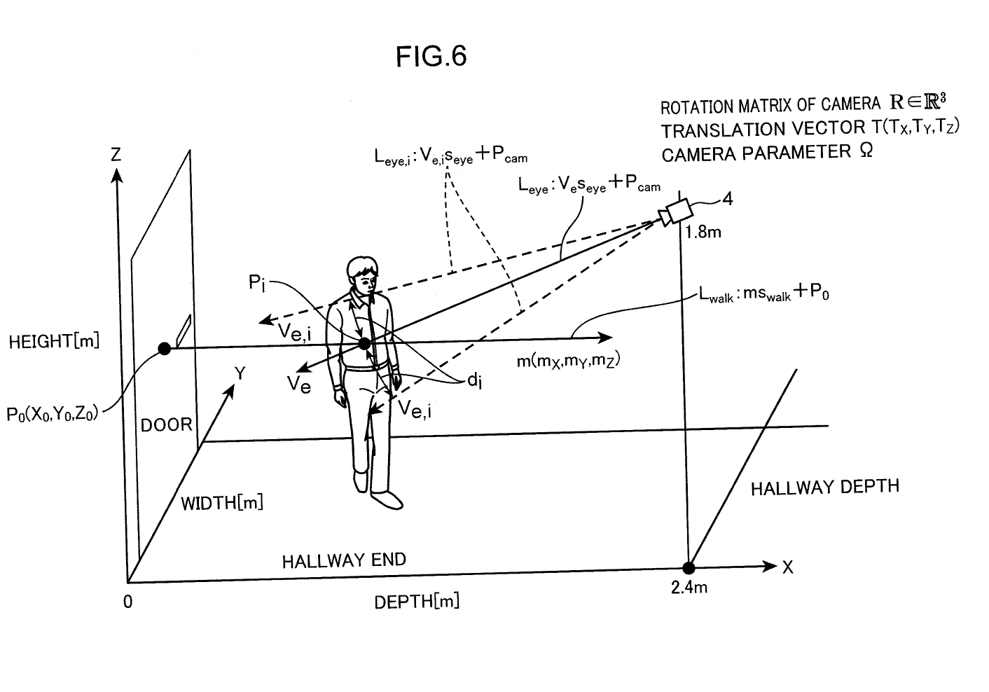

FIG. 6 is a schematic view for explaining the calculation of the camera parameter by the camera parameter calculation part 24. In FIG. 6, a user is walking from a door toward the depth of a hallway. The camera 4 is located above and at the depth of the hallway.

An image coordinate position pᵢ (xᵢ, yᵢ) of a feature point on the i-th image of N-images captured by photographing the user walking at a constant velocity w and a world coordinate position Pᵢ (Yᵢ, Yᵢ, Zᵢ)=(w(i−1)+X₀, Y₀, Z₀) are considered. The sign “i” denotes a frame index. The coordinate “(Z₀, Y₀, Z₀)” indicates an initial three-dimensional position corresponding to the feature point. When the camera parameter is defined as “Ω”, the equation “pᵢ (xᵢ, yᵢ)=Ω(Pᵢ, (Xᵢ, Yᵢ, Zᵢ))” is established, and N-equations are given. Alternatively, N-equations based on the equation “Pᵢ (Xᵢ, Yᵢ, Zᵢ)=Ω⁻¹ (pᵢ (Xᵢ, yᵢ)” are given. Here, a walk straight line L_{walk} indicating a locus of feature points of the user does not agree with a camera sightline straight line L_{eye} indicating an optical axis on the world coordinate system of the camera 4, and thus, each of the N-equations is linear independence. A specific condition, such as a condition that time-series feature points show no movement, is excluded. Specifically, an objective function using a camera parameter is defined and non-linear optimization is performed onto the objective function to enable the calculation of the camera parameter.

The definition of the objective function will be described below. In a case where an inverse function of the camera parameter Ω is used to calculate the equation “Pᵢ (Xᵢ, Yᵢ, Zᵢ)=Ω⁻¹ (pᵢ (xᵢ, yᵢ))”, a scale is unclear. Thus, the position “Pᵢ” is not on a world coordinate based on a single point but on the camera sightline straight line L_{eye}. That is to say, a camera sightline straight line L_{eye, i} for “pᵢ (xᵢ, yᵢ)” is given. When the camera parameter has an error or a difference, the walk straight line L_{walk} indicating a locus of the gravity center of the trunk being a position of a feature point in the three-dimensional space does not intersect the camera sightline straight line L_{eye, i}, and the walk straight line L_{walk} and the camera sightline straight line L_{eye, i} define a distance difference dᵢ (distance between two straight lines) therebetween. The camera sightline straight line L_{eye, i} has a directional vector expressed with the equation “V_{e, i}=P_{cam}Pᵢ”, where the “P_{cam}Pᵢ” is provided with a rightward arrow thereabove, and an auxiliary variable “S_{eye}”, and passes a camera position “P_{cam}”. The camera sightline straight line L_{eye, i} is expressed with the following Equation (5).

$${L}_{eye , i} = {V}_{e , i} {S}_{eye} + {P}_{cam} \qquad ( 5 )$$

In Equation (5), the sign “P_{cam}” denotes a camera position, the sign “V_{e, i}” denotes a directional vector toward the world coordinate position Pᵢ (Xᵢ, Yᵢ, Zᵢ) of the feature point from the camera position P_{cam}, and the sign “S_{eye}” denotes the auxiliary variable. The camera position “P_{cam}” corresponds to the translation vector T (Tₓ, T_{y}, T_{z}). The position “Pᵢ (Xᵢ, Yᵢ, Zᵢ)” is calculated with the equation “Pᵢ (Xᵢ, Yᵢ, Zᵢ)=Ω⁻¹ (pᵢ (xᵢ, yᵢ))” on the basis of the image coordinate position “pᵢ (Xᵢ, yᵢ)” of the feature point.

The walk straight line L_{walk} has a walking directional vector “m (m_{X}, m_{Y}, m_{Z})” and an auxiliary variable “S_{walk}”, and passes a walking start position “P₀”. The walk straight line L_{walk} is expressed with the following Equation (6).

$${L}_{w a l k} = m {s}_{w a l k} + {P}_{0} \qquad ( 6 )$$

The objective function may be defined on the basis of the distance difference dᵢ between the walk straight line L_{walk} and the camera sightline straight line L_{eye, i}. The camera parameter calculation part 24 expresses a plurality of sightline vectors of the camera 4 respectively corresponding to image coordinates of time-series feature points by using time-series feature points calculated by the feature point calculation part 23 and the camera parameter Ω for transformation between the image coordinate system and the world coordinate system. The camera parameter calculation part 24 calculates the camera parameter Ω by minimizing the objective function based on respective distance differences dᵢ between the walk straight line L_{walk} indicating the walking direction of the user and a plurality of camera sightline straight lines L_{eye, i} agreeing with a plurality of sightline vectors. The distance differences dᵢ between the walk straight line L_{walk} and the camera sightline straight lines L_{eye, i} are calculatable by a formula for calculating a distance between a straight line and another straight line.

The camera parameter calculation part 24 uses, as the objective function, a sum of the distance differences dᵢ between the walk straight line L_{walk} and the camera sightline straight lines L_{eye, i}.

The camera parameter calculation part 24 may use, as the objective function, a sum of respective squares of the distance differences dᵢ between the walk straight line L_{walk} and the camera sightline straight lines L_{eye, i}.

Unknown quantities include the rotation matrix R (three degrees of freedom) of the camera, the translation vector T (Tₓ, T_{y}, T_{z}), the walking velocity w, the walking start position P₀ (X₀, Y₀, Z₀), and the walking directional vector m (m_{X}, m_{Y}, m_{Z}). A total of degrees of freedom results in thirteen. When the number “N” represents “13” or larger, the camera parameter calculation part 24 can calculate a camera parameter.

For instance, the Levenberg-Marquardt algorithm is used for the non-linear optimization of the objective function. Exemplary initial values of the parameter will be described below. The camera 4 has a tilt angle of −20°, a pan angle of 0°, and a roll angle of 0°. The camera 4 has a translation vector in which “Tₓ” denotes the depth of 2.4 m shown in FIG. 6 and “T_{y}” denotes the width of 0ₘ shown in FIG. 6, and “T_{z}” denotes the height of 1.8 m shown in FIG. 6. The walking velocity w indicates 3 km per hour. The walking start position P₀ indicates “(0, 0.5, 0.9) [m]”. The walking directional vector m indicates “(1, 0, 0) [m]”. Each of the parameters Tₓ, T_{y}, and T_{z} of the camera position P_{cam} (translation vector T) may have a value measured in advance and may be excluded from variables for calculation of the camera parameter.

This configuration expresses a plurality of sightline vectors of the camera corresponding to image coordinates of the time-series feature points by using the time-series feature points each showing a reference position of the trunk of the user and a camera parameter for transformation between the image coordinate system and the world coordinate system. The camera parameter is calculated by minimizing an objective function based on respective distance differences between the walk straight line indicating the walking direction of the user and the camera sightline straight lines respectively agreeing with a plurality of sightline vectors. When the camera parameter has an error or a difference, the walk straight line does not intersect the camera sightline straight lines, and distance differences between the walk straight line and the camera sightline straight lines are made. The camera parameter is optimized to make each distance difference smallest, so that the camera parameter is calculated. At this time, presence of the same number of time-series images as the number of calculated camera parameters to be calculated leads to achievement of calculation of the camera parameters. This consequently enables calculation of each camera parameter without a calibration index even in a case of a short walking distance.

The aforementioned Non-patent Literature 2 estimates a vanishing point from a locus of each of the head and legs of a person, and thus fails to stably calculate a camera parameter unless a walking distance is long. By contrast, the first embodiment reflects an image coordinate of a gravity center position of a trunk on an objective function without using a vanishing point, and thus enables stable calculation of a camera parameter even with a camera having a lens distortion.

### Second Embodiment

The first embodiment does not consider whether a user being photographed walks straight. In a case where the user being photographed changes a walking direction, an accuracy of calculating a camera parameter may decrease. In this regard, it is determined in a second embodiment whether a user being photographed walks straight.

Hereinafter, only the differences from the first embodiment will be described.

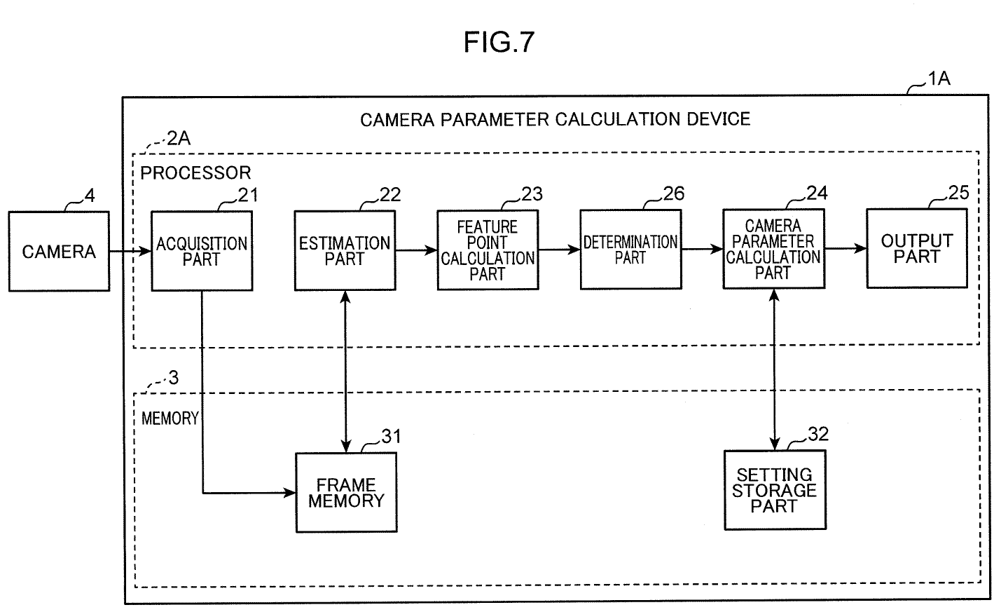

FIG. 7 is a block diagram showing an example of a configuration of a camera parameter calculation system in the second embodiment of the present disclosure.

The camera parameter calculation system in the second embodiment includes a camera parameter calculation device 1A and a camera 4. In the second embodiment, elements which are the same as those in the first embodiment are given the same reference signs and numerals, and thus, description therefor will be omitted.

The camera parameter calculation device 1A is composed of a computer including a processor 2A, a memory 3, and an interface circuit (not shown). The processor 2A has an acquisition part 21, an estimation part 22, a feature point calculation part 23, a camera parameter calculation part 24, an output part 25, and a determination part 26.

The determination part 26 determines, on the basis of time-series feature points calculated by the feature point calculation part 23, whether a user walks straight. The camera parameter calculation part 24 calculates a camera parameter when the determination part 26 determines that the user walks straight.

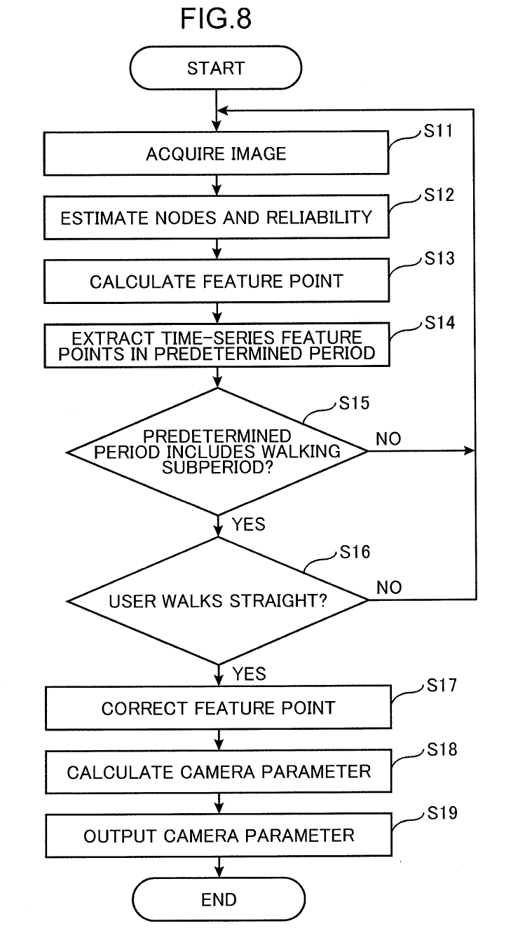

FIG. 8 is a flowchart showing an example of a process of calculating a camera parameter by the camera parameter calculation device 1A in the second embodiment of the disclosure.

Steps S11 to S15 are the same as steps S1 to S5 in FIG. 3, and thus, the descriptions therefor are omitted.

Next, in step S16, the determination part 26 determines whether the user walks straight toward the camera 4. The determination part 26 calculates, on the basis of the following Equation (7), a trunk index for determining whether the front of the user faces in the direction of the camera 4 per frame.

Trunk index=(x-coordinate of left shoulder+x-coordinate of left waist)−(x-coordinate of right shoulder+x-coordinate of right waist) (7)

When the user walks straight toward the camera 4 and the front of the user is photographed, the trunk index always has a positive value. By contrast, when the user turns or turns back in the walking and the back of the user is photographed, the trunk index has a negative value. Such determination of a positive value or a negative value of the trunk index leads to achieved determination as to whether the front of the user faces in the direction of the camera 4.

The determination part 26 determines whether a proportion of the number of frames in which the trunk index has positive values to the total frames in a walking subperiod indicates a threshold or higher. The threshold is, for example, 0.7. The determination part 26 determines that the user walks straight toward the camera 4 when the proportion of the number of frames in which the trunk index has positive values to the total frames in the walking subperiod indicates the threshold or higher. By contrast, the determination part 26 determines that the user does not walk straight toward the camera 4 when the proportion of the number of frames in which the trunk index has positive values to the total frames in the walking subperiod indicates a value lower than the threshold.

When the user is determined not to walk straight toward the camera 4 (NO in step S16), the process returns to step S11.

By contrast, when the user is determined to walk straight toward the camera 4 (YES in step S16), the process proceeds to step S17.

Steps S17 to S19 are the same as steps S6 to S8 in FIG. 3, and thus, the descriptions therefor will be omitted.

The second embodiment achieves calculation of a camera parameter with a high accuracy by removing a feature point resulting from calculation not based on straight walking but based on walking in a different direction that gives an adverse influence on the calculation of the camera parameter.

### Modifications

Heretofore, the camera parameter calculation device according to one or more embodiments of the present disclosure is described, but the present disclosure is not limited to the embodiments. Various modifications applied to the embodiments or configurations obtained by combining constituent elements in the embodiments different from each other conceived by a person skilled in the art may be included in the scope of more features of the present disclosure as far as such modifications and configurations do not deviate from the gist of the disclosure.

In the embodiments, each constituent element may be realized with dedicated hardware or by executing a software program suitable for the constituent element. Each constituent element may be realized by a program execution unit, such as a CPU or a processor, reading out and executing a software program recorded on a recording medium, such as a hard disk or a semiconductor memory. Other independent computer system may implement a program by recording the program in a recording medium to be transferred, or transferring the program via a network.

A part or all of functions of the device according to the embodiment of the disclosure are typically realized as a large scale integration (LSI), which is an integrated circuit. These functions may be formed as separate chips, or some or all of the functions may be included in one chip. The circuit integration is not limited to the LSI, and may be realized with a dedicated circuit or a general-purpose processor. A field programmable gate array (FPGA) that is programmable after manufacturing of an LSI or a reconfigurable processor in which connections and settings of circuit cells within the LSI are reconfigurable may be used.

A part or all of functions of the device according to the embodiment of the present disclosure may be implemented by a processor, such as a CPU executing a program.

Numerical values used above are merely illustrative to be used to specifically describe the present disclosure, and thus the present disclosure is not limited to the illustrative numerical values.

The technology according to the present disclosure achieves calculation of a camera parameter without a calibration index even in a case of a short walking distance, and thus is useful as a technology of calculating the camera parameter.

1. A camera parameter calculation device, comprising:
an acquisition part that acquires an image captured by a camera;
an estimation part that estimates, from time-series images acquired by the acquisition part, time-series node coordinates each indicating an image coordinate of a node of a user;
a feature point calculation part that calculates, on the basis of the time-series node coordinates estimated by the estimation part, time-series feature points each showing a reference position of a trunk of the user; and
a camera parameter calculation part that calculates a camera parameter for transformation between an image coordinate system and a world coordinate system by minimizing an objective function based on respective distance differences between a walk straight line indicating a walking direction of the user and a plurality of camera sightline straight lines respectively agreeing with a plurality of sightline vectors of the camera corresponding to image coordinates of the time-series feature points.

2. The camera parameter calculation device according to claim 1, wherein the sightline vectors are calculated so as to respectively correspond to the image coordinates of the time-series feature points by using the time-series feature points calculated by the feature point calculation part and the camera parameter.

3. The camera parameter calculation device according to claim 1, further comprising an output part that outputs the camera parameter calculated by the camera parameter calculation part.

4. The camera parameter calculation device according to claim 1, wherein the camera parameter calculation part uses, as the objective function, a sum of the distance differences between the walk straight line and the camera sightline straight lines.

5. The camera parameter calculation device according to claim 1, wherein the camera parameter calculation part uses, as the objective function, a sum of respective squares of the distance differences between the walk straight line and the camera sightline straight lines.

6. The camera parameter calculation device according to claim 1, further comprising a determination part that determines, on the basis of the time-series feature points calculated by the feature point calculation part, whether the user walks straight, wherein
the camera parameter calculation part calculates the camera parameter when the user is determined to walk straight.

7. The camera parameter calculation device according to claim 1, wherein the feature point calculation part calculates respective polynomial trendlines for x-coordinates and y-coordinates of the time-series feature points on the basis of the image coordinates of the calculated time-series feature points, and corrects a value on each of an x-coordinate and a y-coordinate of each of the time-series feature points by using the calculated polynomial trendlines for the x-coordinates and the y-coordinates.

8. The camera parameter calculation device according to claim 1, further comprising a setting storage part that stores a distortion parameter indicating a distortion of a lens of the camera in advance, wherein
the camera parameter calculation part uses the distortion parameter stored in the setting storage part as a part of the camera parameter to express the sightline vectors.

9. A camera parameter calculation method in a computer, comprising:
acquiring an image captured by a camera;
estimating, from time-series images having been acquired, time-series node coordinates each indicating an image coordinate of a node of a user;
calculating, on the basis of the estimated time-series node coordinates, time-series feature points each showing a reference position of a trunk of the user; and
calculating a camera parameter for transformation between an image coordinate system and a world coordinate system by minimizing an objective function based on respective distance differences between a walk straight line indicating a walking direction of the user and a plurality of camera sightline straight lines respectively agreeing with a plurality of vectors of the camera corresponding to image coordinates of the time-series feature points.

10. A non-transitory computer readable recording medium storing a camera parameter calculation program, comprising:
causing a computer to serve as:
an acquisition part that acquires an image captured by a camera;
an estimation part that estimates, from time-series images acquired by the acquisition part, time-series node coordinates each indicating an image coordinate of a node of a user;
a feature point calculation part that calculates, on the basis of the time-series node coordinates estimated by the estimation part, time-series feature points each showing a reference position of a trunk of the user; and
a camera parameter calculation part that calculates a camera parameter for transformation between an image coordinate system and a world coordinate system by minimizing an objective function based on respective distance differences between a walk straight line indicating a walking direction of the user and a plurality of camera sightline straight lines respectively agreeing with a plurality of sightline vectors of the camera corresponding to image coordinates of the time-series feature points.
